(19) United States
(12) Patent Application Publication
(10) Pub. No.: US 2008/0208414 A1
(43) Pub. Date: Aug. 28, 2008

(54) Control Apparatus For an Occupant Protection Means in a Motor Vehicle

(75) Inventors: Manfred Linssen, Holzguenz (DE); Karl Moehle, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/663,951

(22) PCT Filed: Aug. 18, 2005
(86) PCT No.: PCT/EP05/08942

§ 371 Date: Dec. 20, 2007

(30) Foreign Application Priority Data
Sep. 29, 2004 (DE) 10 2004 047 906.2

(51) Int. Cl. B60R 21/015

(52) U.S. Cl. 701/46

(57) ABSTRACT

A control apparatus for an occupant protection device in a motor vehicle, including an apparatus for classifying an object and/or occupant on a motor vehicle seat is provided. The control apparatus includes a capacitive force sensor for recording a weight force acting on the motor vehicle seat, which is realized as a measurement capacitor which has at least one elastic, and therefore deformable, plate. The sensor signal is supplied to a control and evaluation circuit which allows the sensor signal to be classified, according to the weight or according to the weight distribution and therefore according to the position of the occupant and/or of the object on the motor vehicle seat, and controls the occupant protection device as a function of the classification. This provides a very robust control apparatus which is of straightforward design and permits very reliable classification and accordingly ensures reliable control of the occupant protection device.

### CROSS REFERENCE TO RELATED APPLICATIONS

This application is a continuation of PCT International Application No. PCT/EP2005/008942, filed Aug. 18, 2005, which claims priority under 35 U.S.C. § 119 to German Patent Application No. 10 2004 047 906.2, filed Sep. 29, 2004, the entire disclosures of which are herein expressly incorporated by reference.

### BACKGROUND AND SUMMARY OF THE INVENTION

The present invention relates to a control apparatus for an occupant protection means in a motor vehicle.

Various control apparatuses for occupant protection means in a motor vehicle are known, these control apparatuses controlling an occupant protection means, such as an airbag or a belt pretensioner, as a function of the weight applied to a motor vehicle seat. For example, German patent document DE 102 29 020 A1 and international patent application WO 2004/013588 A1 disclose a Hall sensor, which is fitted to a vehicle seat, for determining the weight of the vehicle occupant, with the occupant protection means being controlled in a targeted manner as a function of the sensed vehicle weight.

Furthermore, German document patent DE 197 34 508 C2 discloses a control apparatus in which a measurement variable is recorded by a sensor, the measurement is variable depending on the force generated by an electric motor used to adjust the motor vehicle seat. The occupant on the vehicle seat is classified and the occupant protection means is controlled on the basis of the sensor signal. The design of this control apparatus has proven to be highly complex.

Furthermore, U.S. Pat. No. 6,218,632 B1 discloses a control apparatus for an occupant protection device in a motor vehicle. In this document, a capacitive sensor, which is realized in various ways and is arranged between the vehicle seat and the floor of the vehicle, senses the weight force acting on the vehicle seat and uses the sensor signal to control an occupant protection device. The capacitive sensor is in the form of a rigid and stiff differential capacitor whose comb-like plates are mutually displaced toward one another by the active weight force. The design of this control apparatus is complex and susceptible to errors.

An object of the present invention is to specify a control apparatus for an occupant protection device in a motor vehicle, which has a simple design and is less susceptible to errors.

This and other objects and advantages are achieved by a control apparatus for an occupant protection device in a motor vehicle, including an apparatus for classifying an object and/or an occupant on a motor vehicle seat, and a force sensor, which is a capacitive sensor integrated in the motor vehicle seat, for determining a weight force acting on the motor vehicle seat. The weight force detected by the capacitive sensor is supplied in the form of a sensor signal to a control and evaluation circuit, which uses the sensor signal to perform a classification operation according to the weight and controls the occupant protection device (e.g., an airbag or a belt pretensioner) as a function of the classification.

The capacitive sensor has a measurement capacitor which is configured to be deformed by the weight force acting on the motor vehicle seat. The deformation leads to a change in shape or structure of the measurement capacitor, which leads to a defined change in the capacitance of the measurement capacitor corresponding to the weight force. The measured capacitance is supplied to the control and evaluation unit which, given knowledge about the relationship between the changed capacitance and the deformation of the measurement capacitor, makes determinations about the weight force on the motor vehicle seat and controls the occupant protection device in a targeted manner as a function of the determination.

The deformable measurement capacitor provides a very simple and robust design, with low susceptibility to errors, of a force sensor for a control apparatus according to the invention.

It has proven particularly advantageous for the measurement capacitor to be formed with one or more elastic plates, the outer form or shape or the structure of which changes based on the active weight force produced by an occupant or an object on the motor vehicle seat, and, as part of the measurement capacitor, causes a change in capacitance and therefore a changed sensor signal as a result of the deformation of the elastic plate. Using one or more elastic plates produces a simple and robust capacitive sensor which has a particularly long service life and, as a measurement capacitor, is able to provide very reliable information. Moreover, the use of such a measurement capacitor with elastic plates has proven very cost-effective and therefore highly suitable for use in the automobile industry.

A plurality of such deformable measurement capacitors may be provided in the control apparatus, the sensor signals from the measurement capacitors being evaluated together by a common control and evaluation circuit. On account of the use of a plurality of measurement capacitors which have this simple and robust design which is particularly suitable for this control apparatus, it is possible, in conjunction with the one common control and evaluation circuit, to reduce the number of components of the control apparatus and thus firstly to improve the quality of control of the occupant protection device by integrative consideration of the various sensor signals from the plurality of measurement capacitors, and second to improve susceptibility and thus the robustness of the control apparatus. This robustness has proven to be particularly significant for use in a device for improving the safety of the vehicle occupants.

It has also proven particularly favorable to integrate the measurement capacitor or capacitors in the motor vehicle seat. This ensures that damage to the measurement capacitor or capacitors or a change in the measurement capacitors and thus negative influences on the sensor signals and on the quality of the classification are largely precluded due to the external protection of the motor vehicle seat. As a result, it is possible to provide a particularly robust and particularly reliable and safe control apparatus.

It has also proven favorable to integrate the control and evaluation circuit in the vehicle seat in the region of the integrated measurement capacitor or capacitors. These integration operations can be carried out in the seat of the vehicle seat (i.e., the part of the vehicle seat on which a vehicle occupant sits) with the result that the weight force of the sitting vehicle occupant is applied to this seat. As an alternative or in addition, the integrated measurement capacitor or capacitors and/or the integrated control and evaluation circuit can be arranged in the seat backrest. As a result of the integration of the deformable measurement capacitors and of the control and evaluation circuit, the sections for transmission of the sensor signals are selected to be short, with the result that a negative influence on the sensor signals by interference or attenuation on the transmission path is largely precluded, such that amplification or correction of faults in the sensor signals can be largely precluded. This also results in a less complicated control apparatus for an occupant protection device which has also proven to be very robust.

A plurality of measurement capacitors which are integrated in the motor vehicle seat may be arranged in a common plane. In this case, the measurement capacitors may be arranged in the plane such that they are only at a small distance from one another. In this case, the distance from one another is selected such that the deformable measurement capacitors do not touch one another in any sitting position of the seat. The various sensor signals from the various measurement capacitors are supplied to a common control and evaluation circuit which is not only able to detect the weight of the occupant and/or of the object on the vehicle seat, but is also able to determine his/its position on the seat of the vehicle seat. To this end, conclusions are drawn about weight distribution from the different detected changes in capacitance of the various measurement capacitors and, from this, about the position of the center of gravity which is correlated with the position of the occupant and/or of the object on the vehicle seat and equated with the latter.

With the aid of this evaluation according to the present invention, it is possible, given knowledge of the position of the occupant and/or of the object on the vehicle seat, to control the occupant protection device in a targeted manner and in a suitable form, such that the potential for danger is minimized. For example, an airbag is triggered less quickly when the sitting position of the occupant on the vehicle seat is closer to the airbag, that is to say further forward on the sitting surface of the vehicle seat, than when the occupant is sitting on the sitting surface close to the backrest. In addition to the particularly robust design of the control apparatus, this leads to particularly reliable triggering and control behavior for the occupant protection device.

In addition to the inventive deformable measurement capacitor or the measurement capacitors in the seat of the motor vehicle seat, it has additionally also proven particularly favorable to arrange one further measurement capacitor or a plurality of further measurement capacitors in the backrest of the motor vehicle seat, and to supply the generated sensor signals to the common control and evaluation circuit which controls the occupant protection device as a function of the sensor signals. As a result of this, it is possible to use the sensor signals in the backrest to verify the weight distribution of the force sensor in the seat of the motor vehicle seat and thus to provide an even more reliable control apparatus for an occupant protection device.

According to another exemplary embodiment of the control apparatus, a plurality of measurement capacitors are provided in the seat or in the backrest of the motor vehicle seat, with the plurality of measurement capacitors in the seat or in the backrest not being arranged in the same plane but one above the other in a substantially overlapping manner. In particular, the measurement capacitors and the plates of the measurement capacitors are formed in accordance with the size of the sitting surface or of the backrest of the vehicle seat. Arrangement of the deformable measurement capacitors one above the other (overlapped) means it is possible to make the sensor signals from the various measurement capacitors highly comparable and thus enable verification of the respective sensor signals.

It is possible to enable particularly reliable verification of the individual sensor signals as a result of using plates with different degrees of elasticity by the various deformable measurement capacitors. The verification is carried out in the common control and evaluation circuit which, given knowledge of the different elasticities, performs verification reliably and mutually, compares the sensor signals and thus arrives at an integrated and meaningful classification result (e.g., weight result) for the occupant and/or the object on the vehicle seat. This inventive control apparatus for an occupant protection device increases safety of the vehicle occupants in a particularly robust and reliable manner.

It has proven particularly advantageous to arrange the measurement capacitor or capacitors in the motor vehicle seat and to select the measurement capacitor or capacitors such that the sitting surface is entirely or largely detected by the elastic plate of the measurement capacitor, such that the sitting surface is completely or almost completely sensed by the measurement capacitor or capacitors and thus detected. This advantageous selection of the measurement capacitors makes it possible to ensure that a sitting position of an occupant and/or an object on the vehicle seat which is not central leads to a change in the capacitance of the measurement capacitor in the seat of the vehicle seat and leads to a reliable, changed sensor signal. This is interpreted very reliably as a weight signal and leads to differentiated triggering or control of the occupant protection device.

At least one plate of a measurement capacitor may be moisture-permeable or porous. This design of the measurement capacitor makes it possible to provide a very convenient design of the seat with the integrated inventive measurement capacitors which have a very convenient sitting behavior. This ensures that the vehicle seat is able to transport moisture away from the vehicle occupant in difficult climatic conditions, which may be exacerbated by the occupant perspiring on the vehicle seat, which improves desirability of such a seat with the inventive measurement capacitors. The use of reference capacitors ensures that moisture in the vehicle seat and thus in the moisture-permeable measurement capacitor does not lead to incorrect control or incorrect evaluation of the sensor signals on account of the dielectric properties of the measurement capacitor which are changed by the moisture.

Incorrect classification of the occupant and/or of the object sitting on the vehicle seat, particularly with respect to his/its weight or else his/its sitting position, can be reliably precluded as a result. In this case, the reference capacitor may be designed as a measurement capacitor which cannot be deformed and is subjected to the comparable external conditions without itself being deformable, that is to say without experiencing a change in its capacitance as a result of the weight of the occupant and/or of an object on the vehicle seat.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a schematic illustration of an unoccupied vehicle seat having the control apparatus according to the present invention, and

FIG. 2 shows a schematic illustration of a corresponding, occupied vehicle seat.

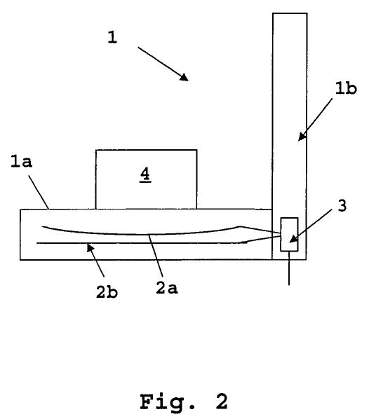

### DETAILED DESCRIPTION OF THE DRAWINGS

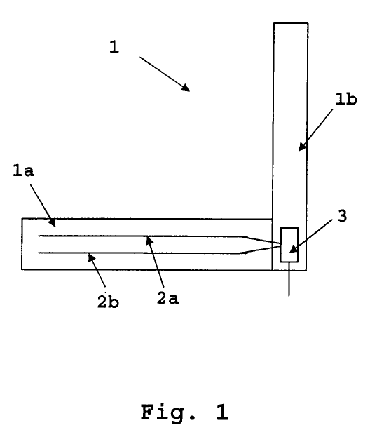

FIG. 1 schematically illustrates a vehicle seat 1, which includes a seat 1a and a backrest 1b, which together form the vehicle seat 1. A measurement capacitor 2 in the form of a capacitive sensor for recording a weight force acting on the motor vehicle seat is arranged in the seat 1a in an integrated manner. The measurement capacitor 2 includes two plates 2a, 2b, which largely span the sitting surface of the seat 1a. A control and evaluation circuit 3 which detects and evaluates the sensor signals from the measurement capacitor 2 is also arranged in the seat 1a. During evaluation, the weight force acting on the motor vehicle seat is derived from the sensor signal or the change in the sensor signal, and the occupant and/or the object on the vehicle seat is therefore classified. The occupant protection device (not illustrated here), which is connected to the control and evaluation circuit 3, is actuated as a function of this classification.

If the seat 1a of the vehicle seat 1 is loaded by an object 4, this leads to an increased weight force on the seat 1a, which leads to the weight 4 being lowered. This increased weight force leads to deformation of the measurement capacitor 2. In this case, the elastic plate 2a of the measurement capacitor 2 is bent, which leads to part of the plate 2a of the measurement capacitor 2 coming closer to the non-deformable plate 2b of the measurement capacitor 2. Other regions of the plate 2a are at a smaller distance from the plate 2b. This deformation of the plate 2a leads to a change in the properties of the measurement capacitor 2, which allow conclusions to be drawn about the weight force of the object 4 on the seat. The control and evaluation circuit 3 which is connected to the measurement capacitor 2 evaluates the sensor signals and compares the sensor signals with reference values which are stored in a reference database in the control and evaluation circuit. This reference database includes a large number of different load situations for the vehicle seat.

Very reliable conclusions can be drawn about the load situation, for example, with respect to the weight and possibly with respect to the position of the object 4, on the basis of the sensor signals or the change in the sensor signals. This design of the measurement capacitor with an elastic, deformable plate provides a very robust design of a measurement capacitor in the form of a capacitive sensor which has a simple design of the control device for controlling an occupant protection device, for example, an airbag, using the inventive measurement capacitor and the control and evaluation circuit. This simple design, in conjunction with very reliable classification of the load situation of the vehicle seat, provides very robust, low-complexity and reliable control of an occupant protection device.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A control apparatus for an occupant protection device in a motor vehicle, comprising:
a capacitive force sensor that records a weight force acting on the motor vehicle seat; and
a control and evaluation circuit that detects signals from the capacitive force sensor, classifies, according to weight, at least one of an object and an occupant on a motor vehicle seat based on the detected signals, and controls the occupant protection device based on a classification of the at least one of the object and the occupant on the motor seat, wherein
a measurement capacitor of the capacitive force sensor is deformable by the weight force acting on the motor vehicle seat, thereby changing the capacitance of the measurement capacitor, and
the control and evaluation circuit evaluates a changed capacitance with respect to classifying the at least one of the object and the occupant on the motor vehicle seat, and to control the occupant protection device based on the changed capacitance.

12. The control apparatus for an occupant protection device in a motor vehicle as claimed in claim 11, wherein at least one plate of the measurement capacitor is elastic.

13. The control apparatus for an occupant protection device in a motor vehicle as claimed in claim 11, wherein the control apparatus has a plurality of measurement capacitors whose sensor signals are evaluated together by the control and evaluation circuit.

14. The control apparatus for an occupant protection device in a motor vehicle as claimed in claim 11, wherein the control and evaluation circuit is arranged in at least one of a seat portion and a backrest portion of the motor vehicle seat.

15. The control apparatus for an occupant protection device in a motor vehicle as claimed in claim 11, wherein the measurement capacitor is arranged in at least one of a seat portion and a backrest portion of the motor vehicle seat.

16. The control apparatus for an occupant protection device in a motor vehicle as claimed in claim 14, wherein:
a plurality of measurement capacitors are integrated in the motor vehicle seat and are arranged in one plane,
sensor signals of the plurality of measurement capacitors are evaluated by the control and evaluation circuit with respect to determining a weight distribution or a position of the at least one of the object and the occupant on the motor vehicle seat, and
the occupant protection device is controlled based on the evaluated sensor signals.

17. The control apparatus for an occupant protection device in a motor vehicle as claimed in claim 14, wherein:
a plurality of measurement capacitors are integrated in the motor vehicle seat and are arranged in different planes such that the measurement capacitors overlap, and
sensor signals of the measurement capacitors are evaluated by the control and evaluation circuit with respect to determining a classification of the at least one of the object and the occupant on the motor vehicle seat for mutual verification of the sensor signals.

18. The control apparatus for an occupant protection device in a motor vehicle as claimed in claim 17, wherein:
the measurement capacitors are arranged to substantially overlap each other and have different elasticities.

19. The control apparatus for an occupant protection device in a motor vehicle as claimed in claim 14, wherein the measurement capacitor is integrated in the seat portion of the motor vehicle seat and is configured to substantially sense a sitting area of the motor vehicle seat.

20. The control apparatus for an occupant protection device in a motor vehicle as claimed in claim 11, wherein the measurement capacitor includes at least one plate which is moisture-permeable and porous.

21. The control apparatus for an occupant protection device in a motor vehicle as claimed in claim 12, wherein the control apparatus has a plurality of measurement capacitors whose sensor signals are evaluated together by the control and evaluation circuit.

22. The control apparatus for an occupant protection device in a motor vehicle as claimed in claim 12, wherein the control and evaluation circuit is arranged in at least one of a seat portion and a backrest portion of the motor vehicle seat.

23. The control apparatus for an occupant protection device in a motor vehicle as claimed in claim 13, wherein the control and evaluation circuit is arranged in at least one of a seat portion and a backrest portion of the motor vehicle seat.

24. The control apparatus for an occupant protection device in a motor vehicle as claimed in claim 12, wherein the measurement capacitor is arranged in at least one of a seat portion and a backrest portion of the motor vehicle seat.

25. The control apparatus for an occupant protection device in a motor vehicle as claimed in claim 13, wherein the measurement capacitor is arranged in at least one of a seat portion and a backrest portion of the motor vehicle seat.

26. The control apparatus for an occupant protection device in a motor vehicle as claimed in claim 14, wherein the measurement capacitor is arranged in at least one of a seat portion and a backrest portion of the motor vehicle seat.

27. The control apparatus for an occupant protection device in a motor vehicle as claimed in claim 15, wherein:
a plurality of measurement capacitors are integrated in the motor vehicle seat and are arranged in one plane,
sensor signals of the plurality of measurement capacitors are evaluated by the control and evaluation circuit with respect to determining a weight distribution or a position of the at least one of the object and the occupant on the motor vehicle seat, and
the occupant protection device is controlled based on the evaluated sensor signals.

28. The control apparatus for an occupant protection device in a motor vehicle as claimed in claim 12, wherein the measurement capacitor includes at least one plate which is moisture-permeable and porous.

29. The control apparatus for an occupant protection device in a motor vehicle as claimed in claim 13, wherein the measurement capacitor includes at least one plate which is moisture-permeable and porous.

30. The control apparatus for an occupant protection device in a motor vehicle as claimed in claim 14, wherein the measurement capacitor includes at least one plate which is moisture-permeable and porous.
